(19) United States
(12) Patent Application Publication
(10) Pub. No.: US 2014/0332635 A1
(43) Pub. Date: Nov. 13, 2014

(54) TANDEM PERSONAL PROPULSION DEVICE

(71) Applicant: JLIP, LLC, Dania Beach, FL (US)

(72) Inventor: Todd Weider, Fort Lauderdale, FL (US)

(73) Assignee: JLIP, LLC, Dania Beach, FL (US)

(21) Appl. No.: 14/276,341

(22) Filed: May 13, 2014

Related U.S. Application Data
(60) Provisional application No. 61/822,612, filed on May 13, 2013.

(51) Int. Cl. B64C 39/02; B64C 19/00

(52) U.S. Cl. CPC B64C 39/026; B64C 19/00
USPC 244/23 A

(57) ABSTRACT

A personal propulsion device, including a passenger assembly configured to support a plurality of passengers, the passenger assembly including one or more nozzles adapted to discharge pressurized fluid; and a pressurized fluid source in fluid communication with the passenger assembly, where the passenger assembly is capable of achieving flight by discharging pressurized fluid provided by the pressurized fluid source. The pressurized fluid source may be a personal watercraft, and the passenger assembly may be configured to support two passengers positioned side-by-side, one in front of the other, or facing different directions.

### CROSS-REFERENCE TO RELATED APPLICATION

This application is related to and claims priority to U.S. Provisional Patent Application Ser. No. 61/822,612, filed May 13, 2013, entitled TANDEM PERSONAL PROPULSION DEVICE, the entirety of which is incorporated herein by reference.

### STATEMENT REGARDING FEDERALLY SPONSORED RESEARCH OR DEVELOPMENT

n/a

### FIELD OF THE INVENTION

The present invention relates to personal propulsion devices using pressurized fluid to achieve flight.

### SUMMARY OF THE INVENTION

A personal propulsion device is disclosed, including a passenger assembly configured to support a plurality of passengers, the passenger assembly including one or more nozzles adapted to discharge pressurized fluid. The system may include a pressurized fluid source in fluid communication with the passenger assembly, wherein the passenger assembly is capable of achieving flight by discharging pressurized fluid provided by the pressurized fluid source. The pressurized fluid source may include a personal watercraft or other source that does not achieve flight with the passenger assembly. The one or more nozzles may include at least one downward-facing nozzle, where the one or more nozzles discharge fluid to directly generate a lifting force sufficient to elevate the passenger assembly. The passenger assembly may be configured to support two passengers positioned side-by-side, one in front of the other, or such that the two passengers face different directions.

The passenger assembly may include a connection point for a hose, and the passenger assembly may be substantially centered about the connection point. The passenger assembly may include a weight compensation mechanism to selectively adjust a weight distribution of the passenger assembly, and the weight compensation mechanism may include at least one connection point to selectively add or remove weighted components from the passenger assembly. The weight compensation mechanism may include a plurality of connection points to selectively add or remove weighted components from the passenger assembly.

The device may include one or more fluid control elements in fluid communication with the one or more nozzles, where the one or more fluid control elements include a controllable valve. The device may include one or more sensors coupled to the passenger assembly and a controller in communication with the one or more sensors, where the one or more sensors may include at least one of an accelerometer, strain gauge, or pressure sensor. The controller may be in communication with the one or more controllable valves to at least partially control fluid flow therethrough, and/or the controller may be operable to control the one or more controllable valves to at least partially attain a selected pitch, yaw, roll, position, or movement of the passenger assembly.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an example of a personal propulsion system constructed in accordance with the principles of the present disclosure;

FIG. 2 is an illustration of another example of a personal propulsion system constructed in accordance with the principles of the present disclosure; and

FIG. 3 is an illustration of still another example of a personal propulsion system constructed in accordance with the principles of the present disclosure.

### DETAILED DESCRIPTION OF THE INVENTION

The present disclosure provides a personal propulsion device or system generally including a passenger assembly that may be configured to carry at least two people and may be further configured to achieve flight through the use of pressurized fluid. The system includes a fluid conduit or hose that delivers pressurized fluid to the passenger assembly, and a pressurized fluid source attached to the conduit. Other pressurized fluid, personal propulsion devices are disclosed in U.S. Pat. Nos. 7,258,301 and 8,336,805, the entirety of all of which are hereby incorporated by reference.

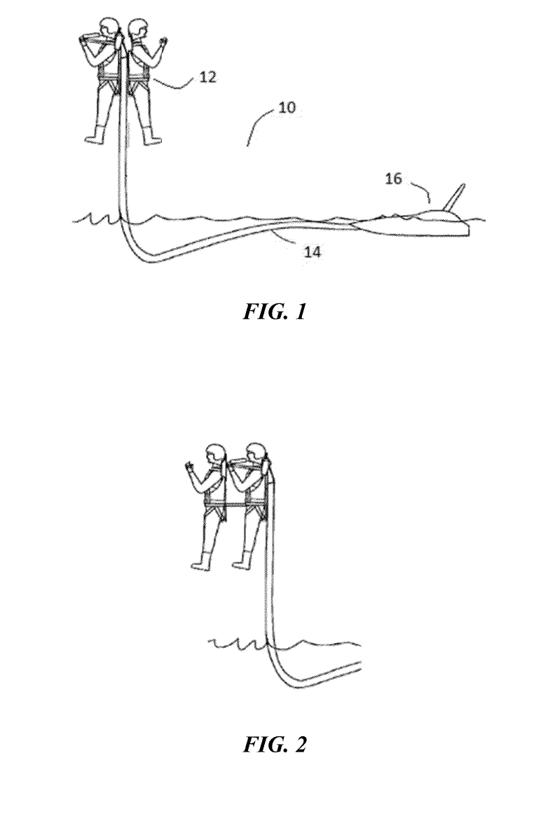

Now referring to FIG. 1, the personal propulsion system 10 is shown with the passenger assembly 12, the fluid conduit or hose 14, and the pressurized fluid source 16. The pressurized fluid source or unit may include an unmanned marine unit, a boat, a personal watercraft such as a wave runner or jet ski, or a pump located on land or in/on water.

The passenger assembly may include one or more components that provide or generate a force to aid in elevating, moving, stabilizing, and/or otherwise controllably using the system. For example, the passenger assembly may include one or more nozzles or outlets that discharged a fluid to move, stabilize, elevate, or otherwise affect the position of the passenger assembly. In the examples shown in FIGS. 1-3, the passenger assembly includes a plurality of downward-facing nozzles that discharge pressurized fluid received from the pressurized fluid source to move, stabilize, elevate or otherwise direct or orient the passenger assembly as desired.

The passenger assembly may include one or more components configured to support at least two people, such as, for example, a first passenger who may control or operate one or more aspects of the system, and a second passenger that may ride along or perform different operational functions, as discussed herein. The passenger assembly may include one or more seats, harnesses, platforms, or other structures facilitating support of the people using or employing the system.

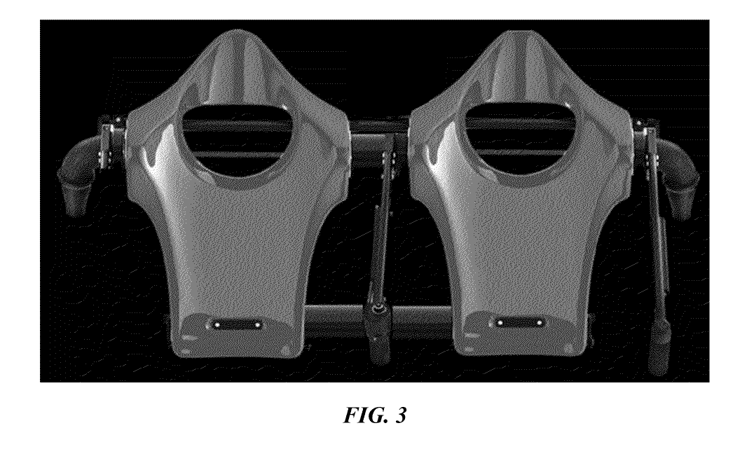

The passenger assembly may be oriented such that the first and second passengers are in tandem, one behind the other, as shown in FIGS. 1 and 2. The orientation of the first and second passengers may be varied. In FIG. 1, for example, the first and second passengers are facing away from each other, while the example in FIG. 2 illustrates the first and second passengers facing the same way. Alternatively, the passenger assembly may orient the first and second passengers side by side, as shown in FIG. 3. Other contemplated orientations include an upper and lower configuration where a first passenger is located above the second passenger, and varying degrees of angular orientation may also be included (i.e., the first and second passengers need not be angularly aligned or parallel to one another). The passenger assembly may be centered about a portion of the delivery conduit (as shown in FIG. 1) to aid in balancing the assembly when the first and second passengers are coupled to the device. Such centering is contemplated for the orientations in each of FIG. 1-3.

The passenger assembly may include a weight compensation system (not shown) that allows the selective distribution or addition of additional weight or mass to the passenger assembly to aid in balancing the total weight of the assembly and passengers about a desired point or axis. For example, should the passenger assembly not be centered on the fluid delivery conduit and/or in the event that the passenger weight distribution about the assembly is uneven, additional weight or mass may be adjustably positioned on or about the passenger assembly to offset such uneven weight distribution. Doing so may reduce any extreme force moments during flight (e.g., whether pitch, yaw, or roll) that result from the uneven weight distribution and/or reduce the need to compensate for the uneven weight distribution through propulsion or thrust provided during operation. The weight compensation system facilitates ease of use of the system when the first passenger has a weight substantially different (whether greater or lesser) than the second passenger. In one example, the weight compensation system may include one or more protrusions coupled to and/or extending form the passenger assembly that are configured to receive one or more weights to allow the selective adjustment of the weight distribution of the overall passenger assembly.

The system may also weight balance or aid in controlling the rotational movement of the passenger assembly about one or more axes by selectively modifying a fluid discharge and/or thrust output of one or more of the nozzles of the passenger assembly. For example, one or more controllable valves may be positioned within a fluid flow path of the particular nozzle(s) or discharge point(s) to controllably and selectively regulate or adjust a fluid flow there through, and thus adjust the resulting discharge force or thrust or the expelled fluid. The one or more valves may be located on or about the passenger assembly, the hose, and/or the pressurized fluid source.

The thrust output of a particular nozzle or discharge port may be configured for manual and/or automated operation. In an example of an at least partially automated configuration, the system may include one or more sensors coupled to one or more portions of the passenger assembly to detect a weight, force, moment, or movement thereof (e.g., one or more accelerometers, strain gauges, or otherwise). The one or more sensors may be in communication with a controller and/or processor that receives information from the one or more sensors, where the controller processes, calculates or otherwise determines a weight distribution, pitch, yaw, roll, or other orientation and/or movement characteristics of the passenger assembly. The controller may be located on the passenger assembly, the hose, or on the pressurized fluid source. The controller may then communicate to one or more valves or other fluid control components of the system to adjust fluid flow through all or a portion of the system to affect the resulting thrust or discharge force generated form the fluid flow to achieve a desired movement or orientation in view of the detected information.

The weight balancing and/or at least partially automated fluid flow/thrust control examples disclosed herein are equally applicable to both multi-passenger and single-passenger configurations of a passenger assembly or personal propulsion device, including both single and multi-passenger variations of the devices disclosed in U.S. Pat. Nos. 7,258,301 and 8,336,805.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A personal propulsion device, comprising:
a passenger assembly configured to support a plurality of passengers, the passenger assembly including one or more nozzles adapted to discharge pressurized fluid.

2. The system of claim 1, further comprising a pressurized fluid source in fluid communication with the passenger assembly, wherein the passenger assembly is capable of achieving flight by discharging pressurized fluid provided by the pressurized fluid source.

3. The system of claim 2, wherein the pressurized fluid source is a personal watercraft.

4. The system of claim 1, wherein the one or more nozzles include at least one downward-facing nozzle.

5. The system of claim 1, wherein the one or more nozzles discharge fluid to directly generate a lifting force.

6. The system of claim 5, wherein the lifting force is sufficient to elevate the passenger assembly.

7. The system of claim 1, wherein the passenger assembly is configured to support two passengers positioned side-by-side.

8. The system of claim 1, wherein the passenger assembly is configured to support two passengers positioned one in front of the other.

9. The system of claim 8, wherein the passenger assembly is configured to orient the two passengers facing different directions.

10. The system of claim 1, wherein the passenger assembly includes a connection point for a hose, and wherein the passenger assembly is substantially centered about the connection point.

11. The system of claim 1, wherein the passenger assembly includes a weight compensation mechanism to selectively adjust a weight distribution of the passenger assembly.

12. The system of claim 11, wherein the weight compensation mechanism includes at least one connection point to selectively add or remove weighted components from the passenger assembly.

13. The system of claim 11, wherein the weight compensation mechanism includes a plurality of connection points to selectively add or remove weighted components from the passenger assembly.

14. The system of claim 1, further comprising one or more fluid control elements in fluid communication with the one or more nozzles.

15. The system of claim 14, wherein the one or more fluid control elements include a controllable valve.

16. The system of claim 14, further comprising one or more sensors coupled to the passenger assembly and a controller in communication with the one or more sensors.

17. The system of claim 16, wherein the one or more sensors include at least one of an accelerometer, strain gauge, or pressure sensor.

18. The system of claim 16, wherein the controller is in communication with the one or more controllable valves to at least partially control fluid flow therethrough.

19. The system of claim 18, wherein the controller is operable to control the one or more controllable valves to at least partially attain a selected pitch, yaw, roll, position, or movement of the passenger assembly.
